(19) United States
(12) Patent Application Publication
(10) Pub. No.: US 2004/0032117 A1
(43) Pub. Date: Feb. 19, 2004

(54) Seat back load sensor

(76) Inventors: Nicholas W. Pinto IV, Ferndale, MI (US); Scott B. Gentry, Romeo, MI (US); Hossam Almasri, Sterling Heights, MI (US); Edward W. Clancy III, Novi, MI (US); Mohannad F. Murad, Troy, MI (US)

Correspondence Address: KEY SAFETY SYSTEMS, INC., PATENT DEPARTMENT, 5300 ALLEN K BREED HIGHWAY, LAKELAND, FL, 33811-1130, US

(21) Appl. No.: 10/222,879

(22) Filed: Aug. 19, 2002

(51) Int. Cl. B60R 21/32

(52) U.S. Cl. 280/735

(57) ABSTRACT

A vehicle seat occupant position sensor has one of four mechanisms to provide input with respect to how a seat occupant is engaged with a seat back. The first mechanism has some of the individual tension wires forming the flexolator pass through magnetostrictive sensors to detect in wire tension. Another mechanism employs a potentiometer geared so that relative deflection between the seat back and the seat recliner is amplified. A further mechanism is a magnetostrictive sensor that senses the stress in a seat back structure that is loaded by the seat occupant leaning against the seat back. Lastly, a bladder filled with a fluid provides pressure measurements as an indicator of the force generated by the vehicle seat occupant leaning against the seat back.

### BACKGROUND OF THE INVENTION

The present invention relates to vehicle safety systems that use deployment logic that takes into account the position of a vehicle occupant.

It is generally recognized by those in the automobile industry that the decision to deploy an airbag can be improved if the presence and position of the occupant can be determined before bag deployment. If the position of an occupant is known, deployment can be prevented or varied in response to the position of the occupant.

One known approach to determine the position of a vehicle occupant is to determine the position of the car seat, particularly for the driver's side seat. Other sensors such as capacitance sensors have been considered for determining the presence of the driver in relation to both the vehicle seat and the seat back. Alternatively, various techniques employing ultrasound have been employed to detect and characterize the occupant's position on the seat. Sensors, such as rotary potentiometers, have been mounted to a vehicle seat recliner to determine seat back inclination angles. Various sensors have been used to detect and even measure the weight of the occupants in a vehicle seat. Such sensors have included pressure sensors, fluid within a bladder, load cells, and sensors employing the inverse-magnetostrictive effect such as shown in U.S. Pat. No. 5,739,757 which is incorporated herein by reference.

Many approaches to detecting a seat occupant's position with respect to a seat back have also been considered, using the capacitance sensor as suggested in U.S. Pat. No. 6,292,727. U.S. Pat. No. 6,302,438 suggests any of a number of rangefinder sensors including capacitance, optical, ultrasonic or radar to detect the distance between the seat occupant's back and the seat back. U.S. Pat. No. 6,015,163 suggests using flexible potentiometers that are mounted on some sort of deflectable or bendable substrate to which the variable resistant material is applied so that the presence of the person in the seat, the position of the person and the profile of the person may be detected. U.S. Pat. No. 5,074,583 discloses five sets of pressure sensors, where the pressure sensors are comprised of a pair of electrical conductors such as aluminum alloy, and an electrical insulator such as resilient synthetic resin between the conductors so that pressure on the conductors causes a change in the electrostatic capacitance of the sensors. U.S. Pat. No. 6,242,701 suggests the use of motion sensors utilizing a micro-power impulse radar system positioned within the seat back.

While various approaches have been proposed for deploying an airbag based on greater intelligence concerning the actual position of a vehicle occupant, the importance in terms of possible improved safety makes the development of new approaches for determining the position of a person with respect to a vehicle seat of considerable importance.

### SUMMARY OF THE INVENTION

The vehicle seat occupant position sensor of this invention employs one of four mechanisms to determine whether the seat occupant is engaged with a seat back, and the extent of that engagement. The first mechanism employs a vehicle seat back containing a flexolator in which some of the individual tension wires forming the flexolator pass through magnetostrictive sensors such as disclosed in U.S. Pat. No. 5,739,757 which is incorporated herein by reference. The magnetostrictive sensors detect a change in wire tension that provides an indication of the load or force with which the seat occupant's back engages with the seat back of the vehicle seat.

A second mechanism employs a potentiometer connected by a gear so that relative movement between the seat back and the seat recliner is amplified. In this way the small elastic deflections of the seat back in response to the seat occupant leaning against the seat back are amplified and made available to the airbag deployment logic.

A third mechanism is a magnetostrictive sensor that senses the stress in a seat back recliner, or recliner bracket, when the recliner is loaded by the seat occupant leaning against the seat back.

A fourth mechanism is a bladder filled with a fluid such as air or an ethylene glycol mix. Pressure within the bladder is used as an indicator of the force generated by the vehicle seat occupant leaning against the seat back.

Each of the foregoing mechanisms provides an indication of the force with which the seat occupant is engaged with the back of the vehicle seat. This information can be correlated with a seat occupant's position on the seat by comparing the output from the various mechanisms when the seat occupant assumes various positions.

It is a feature of the present invention to provide input to a safety system deployment logic that is indicative of a vehicle occupant's position with respect to the seat back of a vehicle seat.

It is another feature of the present invention to provide a means for sensing stress in the back of a vehicle seat that can be correlated with the seat occupant's position.

It is a further feature of the present invention to provide magnetostrictive sensors that can be used to determine a vehicle occupant's position with respect to the back of a vehicle seat.

Further features and advantages of the invention will be apparent from the following detailed description when taken in conjunction with the accompanying drawings.

### BRIEF DESCRIPTION OF THE DRAWINGS

FIG. 1 is an isometric view partly cutaway of a vehicle seat back showing a flexolator employing magnetostrictive sensors and a fluid bladder contained within the seat back cushion.

FIG. 2 is a partial schematic view of a vehicle seat recliner and seat back with a geared mechanism connecting a potentiometer between the seat back recliner and the seat back recliner support.

FIG. 3 is a fragmentary, partly cutaway, side elevational view of a magnetostrictive sensor for sensing the stress in a seat back recliner support.

FIG. 4 is a block diagram for the vehicle safety systems of this invention.

FIG. 5 is an isometric view of the magnetostrictive sensor of FIG. 3 wherein the sensor is shown in an alternative position.

### DETAILED DESCRIPTION OF THE INVENTION

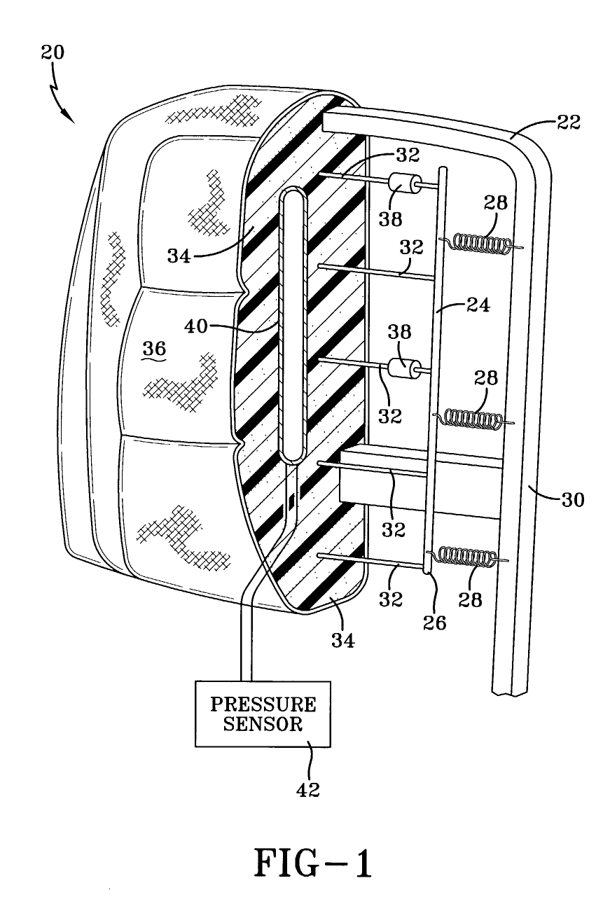

Referring to FIGS. 1B4, wherein like numbers refer to similar parts, a vehicle seat back 20 is shown in FIG. 1. The seat back 20 has a frame 22 to which is mounted a flexolater 24. The flexolator 24 has a pair of parallel rods 26, only one of which is visible in FIG. 1, that are mounted by springs 28 to the sides 30 of the seat back frame 22. Stretched between the rods 26 are support wires 32. Resilient foam 34, which is shown cutaway in FIG. 1, is molded over the seat frame 22 and the flexolator 24. A seat cover 36 encloses the resilient foam 34, the seat back frame 22, and the flexolator 24 to form the vehicle seat back 20. The support wires 32 are under tension. The level of tension in particular support wires will depend upon how a seat occupant is positioned on the vehicle seat, and more particularly upon how the seat occupant is engaged with the seat back 20. As disclosed in U.S. Pat. No. 5,739,757, it is possible to use a magnetostrictive sensor 38 to detect the tension in the support wires 32.

First reported by Joule in 1847, the magnetostrictive effect describes a small change in physical dimensions of ferromagnetic materials in the presence of a magnetic field. The opposite effect known as the inverse magnetostrictive effect results in the generation of an electromagnetic field when a ferromagnetic material undergoes strain. Sensors capable of detecting stress in materials using the magnetostrictive effect employ a first coil that generates an oscillating magnetic field that produces oscillating stress in a ferromagnetic material, and a second coil that detects the magnetic field produced by the strain in the ferromagnetic material produced by the first coil. Strains in the ferromagnetic material produced by the first coil are modulated by the static stress in the ferromagnetic material and thus can be detected by the second coil. Magnetostrictive sensors have the potential of being reliable and operating over a large temperature range making them suitable for use in automobile applications.

A second and distinct approach for determining the position of vehicle occupants with respect to the seat back 20 is the use of an fluid bladder 40 which is illustrated in FIG. 1 as being foamed in place. The bladder connects to a pressure sensor 42 such as is well known in the art. The output of the pressure sensor 42 is used as an indicator of the seat occupant's position relative to the seat back 20. Although U.S. Pat. No. 5,739,757 describes the use of an air bladder for determining the seat occupant's weight, and lists various problems encountered in such an application, the use of an air bladder in the seat back is less demanding because absolute accuracy is less necessary. A relative measurement that compares bladder pressure when the seat is unoccupied with a bladder pressure when the seat is occupied is sufficient as an input to an occupant position modeling algorithm.

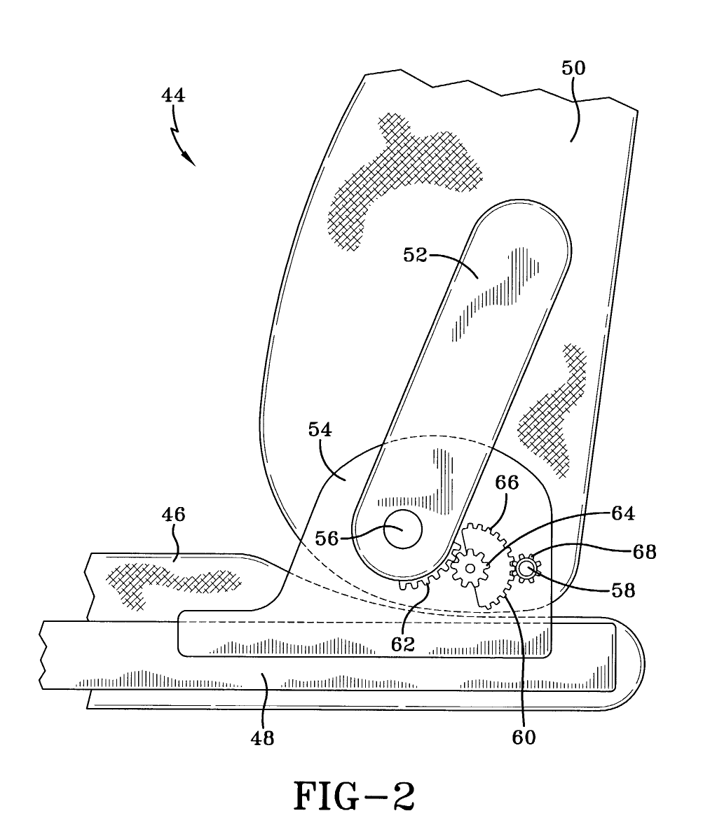

A typical car seat 44 structure, as shown in FIG. 2, has a seat bottom 46 that is mounted to a top rail 48 which is laterally adjustable on a bottom rail (not shown) that is structurally mounted to the floor of a vehicle. The car seat 44 has a seat back 50 that is structurally joined to the seat bottom 46 by a recliner 52 mounted to a recliner bracket 54. The recliner 52 is mounted about a pivot pin 56, and the recliner bracket 54 is mounted to a top rail 48. By this arrangement, the structural loading on the seat back 50 is transferred to the top rail 48 and then to a bottom rail mounted to the floor of a vehicle. The car seat 44 illustrated in FIG. 2 has a simplified connection between a seat back 50 and the seat bottom 46, the actual arrangements are typically more mechanically complex and allow for manual or motorized adjustment between the seat back and the seat bottom. However all car seats require a structure for transferring the loads between the seat back and the seat bottom or seat top rail. The transfer of the load imposed on the seat back to the seat bottom or seat top rail produces a strain or deflection between the seat back and the seat bottom or top rail.

The third approach to determining a vehicle seat occupant's position with respect to the vehicle seat back 50 can be accomplished by connecting a potentiometer 58 through a gear train 60 to structural portions of the seat that deflect with respect to one another as the seat back 50 is loaded. The gear train 60 amplifies the deflection of the seat back with respect to the seat bottom and the potentiometer measures the amplified deflection as a changing resistance.

The gear train 60 illustrated in FIG. 2 has a partial gear 62 formed as part of the recliner structure 52 which engages a small second gear 64, that is mounted to a larger gear 66 that turns a gear 68 mounted to the potentiometer 58 which is mounted to the recliner bracket 54. A slight deflection of the recliner structure 52 with respect to the recliner bracket 54 produces a substantial rotation of the potentiometer 58.

It will be understood that the gear train 68 illustrated in FIG. 2 will in general be specifically designed to amplify the occupant-induced strains between the seat back and the seat bottom, while accommodating whatever adjustment functions are considered necessary for a particular seat design. Thus the particular arrangement of the gear train will depend upon the design of a particular vehicle seat, but the gearing of a potentiometer to the relative deflection between the seat back and the seat bottom or seat bottom rail will remain a constant.

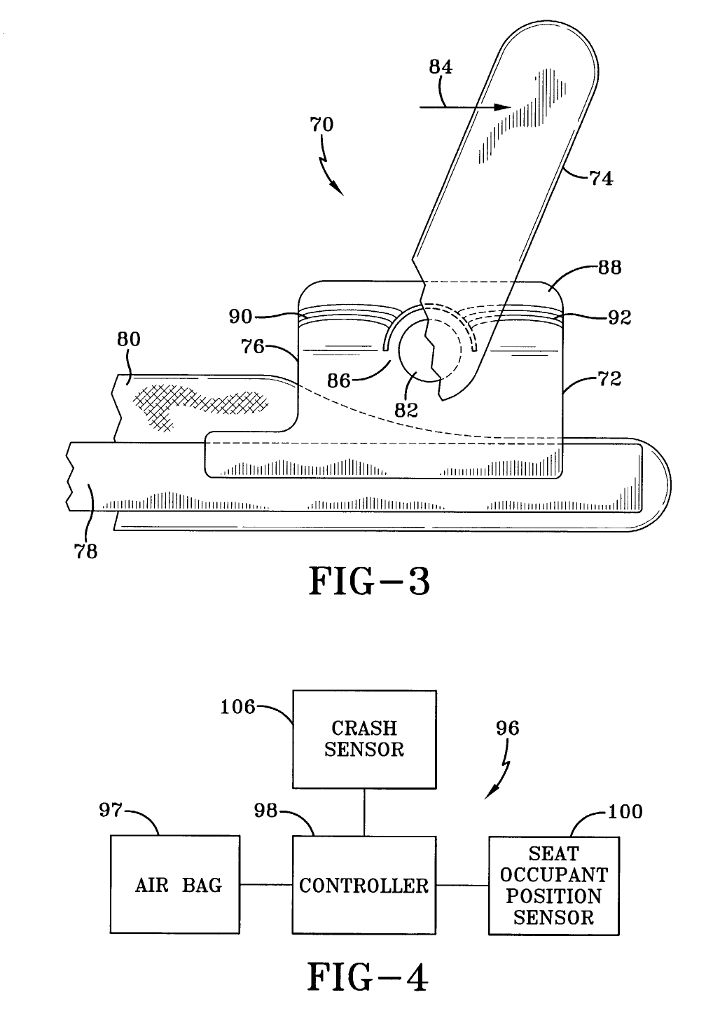

FIG. 3 illustrates portions of a car seat 70 where strains induced in a recliner bracket 72 by loads transmitted from a seat back (not shown) through a recliner 74 are monitored by a magnetostrictive sensor 76. The recliner bracket 72 is mounted to the top rail 78 of the seat 80. The recliner 74 is mounted about a pin 82 to the recliner bracket 72 so that backward force indicated by arrow 84 produces elastic strain in the body 86 of the recliner bracket 72. The recliner bracket 72 has a portion that forms a U-shaped flange 88 such as might be formed by stamping and shearing the recliner bracket 72. A first coil 90 is formed on one side of the U-shaped flange 88 leading into one side of the body 86 of the recliner bracket 72 and a second coil 92 is formed on the second side of the U-shaped flange 88 leading into a second side of the body 86 of the recliner bracket 72. The first coil 90 is driven with an alternating current to induce an alternating stress wave that passes through the body 86 and into the second side of the U-shaped flange 88 where the alternating stress wave is detected by the second coil 92. The magnetostrictive sensor 76 is thus formed between the first coil 90 and the second coil 92 and allows the solid-state monitoring of stress in the recliner bracket 72. Stress in the bracket 72 is correlated with how the seat back is engaged by the seat occupant because the engagement causes stress in the recliner 74. An isometric view of the car seat 70 is shown in FIG. 5, wherein the U-shaped flange 88 is shown bent to a greater angle with respect to the recliner bracket 72.

It will be understood that a magnetostrictive sensor can be formed in other ways such as by welding or bonding of ferromagnetic cores about which the first and second coils are formed. In general, magnetostrictive sensors can be used with any portion of the seat back and its attachment to the seat bottom or upper rail that experiences a representative stress, i.e., stress that proves useful in determining a vehicle seat occupant's position relative to the seat back.

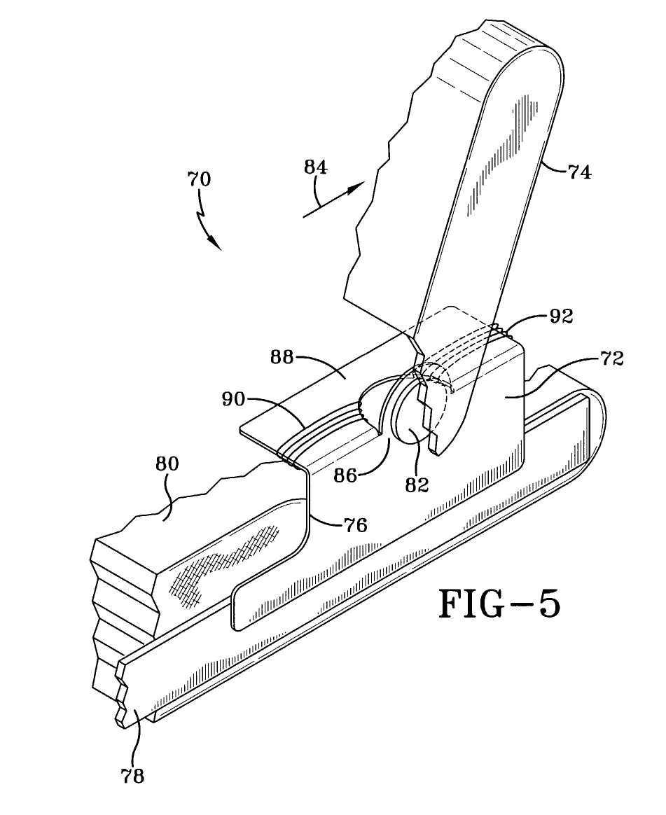

FIG. 4 shows a simplified diagram for a vehicle safety system 96 having a safety device 97, a safety device controller 98, and a seat occupant position sensor 100. The safety device 97 may be an airbag; either a side impact airbag, or a front airbag. The airbag may be of the two-stage type, or have a variable gas volume deployment capability. The controller 98 determines whether or not to deploy the airbag based on one or more crash sensors 106. The airbag controller 98 considers the type and severity of the crash as determined by input from the crash sensors and onboard logic. The airbag controller 98, depending on the functionality of the airbag, makes the decision whether or not to deploy the airbag, and if the airbag is capable of veritable deployment, as to gas pressure, timing, deployment velocity or other factor, the controller uses onboard logic to control one or more deployment variables. In addition to considering attributes of the crash, and other sensors within the vehicle, such as seat occupant weight, seat belt use, radar, ultrasound, or optical sensors, the controller and the onboard logic consider input from the seat occupant position sensors. The seat position sensors described herein can be used to determine through experimentation, modeling, crash testing, and black box monitoring of real world crashes, correlations between the output of the sensors and the optimal method of deploying a safety device so as to minimize the unfavorable results of a vehicle crash. In this way the vehicle occupant sensors disclosed herein can be seen to be tools which can be used to improve vehicle crash outcomes.

It should be understood that magnetostrictive sensors, while requiring ferromagnetic materials to generate and detect stress waves, can be used to detect stresses in nonferromagnetic materials by joining stress-wave-producing ferromagnetic components to nonferromagnetic structures.

It should also be understood that more than one type of vehicle occupant seat position sensor could be used on the same vehicle seat. Furthermore, the seat occupant position sensors described herein could be used in conjunction with seat occupant position sensors such as capacitance sensors, or those which utilize ultrasound, radar, or light to directly image or otherwise detect the seat occupant's position relative to an airbag or other point of reference.

It is further to be understood that vehicle seats take on a wide variety of structural designs, and that various seat occupant position sensors may be adapted to the various designs within the limitations set forth in the following claims.

It is understood that the invention is not limited to the particular construction and arrangement of parts herein illustrated and described, but embraces all such modified forms thereof as come within the scope of the following claims.

We claim:

1. A vehicle safety system of the type having:
a safety device;
a safety device controller;
a seat occupant position sensor; and
wherein the safety device controller is in information receiving relation with the seat occupant position sensor and is in controlling relation with the safety device, wherein the improvement comprises:
a plurality of wires under tension forming a part of a vehicle seat back structure, at least one magnetostrictive sensor positioned with respect to one of said plurality of wires to detect the tension, the magnetostrictive sensor forming the seat occupant position sensor.

2. The vehicle safety system of claim 1 wherein the plurality of wires under tension are part of a flexolater which is resiliently mounted to a portion of the seat back structure.

3. The vehicle safety system of claim 1 further comprising two magnetostrictive sensors positioned with respect to each of two wires of the plurality of wires to detect the tension in each of the two wires.

4. The vehicle safety system of claim 1 wherein the safety device is an airbag.

5. A vehicle safety systems of the type having:
a safety device;
a safety device controller;
a seat occupant position sensor; and
wherein the safety device controller is in information receiving relation with the seat occupant position sensor and in controlling relation with the safety device, wherein the improvement comprises:
a vehicle seat having a first structural element and a vehicle seat back having a second structural element so that as the seat back is loaded the second structural element elastically deflects with respect to the first structural element and a gear train extending between one of said first and second structural elements and a rotating potentiometer mounted to the other of said first and second structural elements, the gear train amplifying the elastic deflection, and causing the rotating potentiometer to rotate, the potentiometer forming the seat occupant position sensor.

6. The vehicle safety system of claim 7 wherein the safety device is an airbag.

7. A vehicle safety system of the type having:
a safety device;
a safety device controller;
a seat occupant position sensor;
wherein the safety device controller is in information receiving relation with the seat occupant position sensor and controlling relation with the safety device, wherein the improvement comprises:
a vehicle seat back, and positioned within the vehicle seat back a fluid filled bladder communicating with a pressure sensor, the pressure sensor forming the seat occupant position sensor.

8. A vehicle safety system of the type having:
a safety device;
a safety device controller;
a seat occupant position sensor;
wherein the safety device controller is in information receiving relation with the seat occupant position sensor and controlling relation with the safety device, wherein the improvement comprises:
a vehicle seat having a first structural element and a vehicle seat back having a second structural element so that as the seat back is loaded the first structural element undergoes an elastic strain induced by the second structural element; and
a magnetostrictive sensor engaged with the first structural element to detect the elastic strain in the first structural element, the magnetostrictive sensor forming the seat occupant position sensor.

9. The vehicle safety system of claim 8 wherein the safety device is an airbag.

10. The vehicle safety system of claim 8 wherein the first structural element is made of a ferromagnetic material, and wherein a U-shaped ferromagnetic element has a first coil formed on a first side of the U-shaped element leading into the first structural element and a second coil formed on the second side of the U-shaped element leading into a second side of the first structural element.
